(19) United States
(12) Patent Application Publication
(10) Pub. No.: US 2024/0210175 A1
(43) Pub. Date: Jun. 27, 2024

(54) INTEGRATED PHOTONICS CHIP WITH ELECTRO-OPTIC MATERIAL BASED WAVEGUIDE COMPONENTS

(71) Applicant: Anello Photonics, Inc., Santa Clara, CA (US)

(72) Inventors: Mario Paniccia, Santa Clara, CA (US); Avi Feshali, Los Angeles, CA (US); Mike Horton, Santa Clara, CA (US)

(21) Appl. No.: 18/389,663

(22) Filed: Dec. 19, 2023

Related U.S. Application Data
(60) Provisional application No. 63/476,764, filed on Dec. 22, 2022.

(51) Int. Cl. G01C 19/72

(52) U.S. Cl. CPC G01C 19/727; G01C 19/725

(57) ABSTRACT

An integrated photonics optical gyroscope front-end chip is fabricated on a waveguide platform made of electro-optic materials. The front-end chip launches light into and receive light from the rotation sensing element, that can be a fiber spool or a waveguide coil/microresonator ring. The waveguide coil/microresonator ring can be made of the same electro-optic material platform or a different material platform. External elements (e.g., laser, detectors, phase shifter) may be made of different material platform than the electro-optic material and can be hybridly integrated or otherwise coupled to the waveguide platform. Additional phase shifters can be made of piezo-electric material or can be thermal phase shifters.

### RELATED APPLICATIONS

This application is related to and claims the benefit of U.S. Provisional Patent Application No. 63/476,764, filed Dec. 22, 2022, titled “Integrated Photonics Chip With Electro-Optic Material Based Waveguide Components,” the entirety of which is incorporated herein by reference.

### TECHNICAL FIELD

The present disclosure relates to an integrated photonics chip fabricated on a material platform where the waveguides themselves have electro-optic properties.

### BACKGROUND

Gyroscopes (sometimes also referred to as “gyros”) are devices that are able to sense angular velocity. Gyroscopes can be mechanical or optical, and vary in precision, performance cost and size. The applications include, but are not limited to, military, aircraft navigation, robotics, autonomous vehicles, virtual reality, augmented reality, gaming etc. Optical gyroscopes typically have the highest performance and are based on interferometric measurements and the Sagnac effect (a phenomenon encountered in interferometry that is elicited by rotation). Since optical gyroscopes do not have any moving parts, they have advantages over mechanical gyroscopes as they can withstand effects of shock, vibration and temperature variation better than the mechanical gyroscopes with moving parts. The most common optical gyroscope is the fiber optical gyroscope (FOG). Construction of a FOG typically involves a coil comprising several loops/turns of polarization-maintaining (PM) fiber. Laser light is launched into both ends of the PM fiber coil traveling in opposite directions. If the fiber coil is moving, the optical beams traveling in opposite directions experience different optical path lengths with respect to each other. By setting up an interferometric system, one can measure the small path length difference that is proportional to the area of the enclosed loop and the angular velocity of the rotating fiber coil.

Phase signal of an optical gyro is proportional to the Sagnac effect times the angular rotation velocity, as shown in the following equation:

$$Δ ϕ = ( 8 π N A / λ c ) Ω$$

where, N=number of turns in the gyro; A=area enclosed; Ω=angular rotation velocity; Δϕ=optical phase difference signal; λ=wavelength of light; and c=speed of light.

These FOGs can have very high precision, but at the same time, they are of large dimension, and are hard to assemble due to the devices being built based on discrete optical components that need to be aligned precisely, resulting in a more expensive gyroscope module. Often, manual alignment is involved, and fiber splicing is required, which is hard to scale up for volume production. This application discloses a compact integrated photonics front-end chip to launch light into a fiber-optic coil or another waveguide based coil/microresonator ring, where the front-end chip has waveguides made of a material having electro-optic properties. The waveguide-based coil/microresonator ring can also be made of material platform having electro-optic properties or other material platform.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the present disclosure, an optical gyroscope is disclosed, where the gyroscope comprises: a rotation sensing element (e.g., a fiber coil, or a waveguide coil/microresonator ring); and a front-end chip to launch light into and receive light from the rotation sensing element. The front end chip is fabricated on a material platform having electro-optic properties, such as crystalline (single or poly-crystalline) lithium niobate or lithium tantalate. Some optical elements, such as lasers and photodetectors can be fabricated using a material platform other than the electro-optic material platform. The sensing element can be fabricated on the same electro-optical material platform or a different material platform.

Additional phase shifters made of a material other than the electro-optic material platform, can be hybridly integrated or otherwise coupled to the front-end chip. For example, the phase shifter can be fabricated by depositing metal or ceramic/polymer materials having piezoelectric (and/or electro-optic) properties on the front-end chip. Alternatively, the additional phase shifter can be fabricated by growing, wafer-bonding or attaching III-V compound semiconductor material on the front-end chip. Depending on the material chosen, additional phase shifting can be thermal (using metallic heaters) or piezo-electric.

In some embodiments, a common substrate with the light source (such as semiconductor lasers, including quantum dot lasers) and the detectors can be flip-chip bonded or wafer-bonded to the electro-optic material platform.

In some other embodiment, the common substrate can be butt-coupled or coupled via a lens to the front-end chip with the input waveguides aligned to the light source and the detectors.

The light sources and the detectors can be all fabricated on a separate layer that is hybridly integrated or otherwise coupled (such as discrete devices that are fiber-coupled) with the electro-optic material platform.

The light sources can also be hybridly integrated with the electro-optic material platform by bonding or selectively growing III-V materials. Similarly, photodetectors can also be hybridly integrated by selectively depositing or growing photodetector materials (e.g., germanium or silicon germanium or other compound semiconductors).

### BRIEF DESCRIPTION OF THE DRAWINGS

The present disclosure will be understood more fully from the detailed description given below and from the accompanying drawings of various implementations of the disclosure. Please note that the dimensions shown in the figures are for illustrative purposes only and not drawn to scale.

FIG. 1 is a schematic of an integrated photonics front-end chip that couples to a rotation sensing element, according to an embodiment of the present disclosure.

FIG. 2A is a simplified schematic of an optical gyroscope where an off-chip laser is coupled to an integrated photonics front-end chip, which in turn couples to a sensing chip with a rotation sensing element (a waveguide coil in this example), according to an embodiment of the present disclosure. The front-end chip is made from a material platform having electro-optic properties. The sensing chip is made of the same material platform as the front-end chip or a different material platform.

FIG. 2B is a simplified schematic of an alternative embodiment of the optical gyroscope shown in FIG. 2A, where an additional phase modulator is added in between the off-chip laser and the first optical coupler (a directional coupler in this example).

FIG. 2C is a simplified schematic of an optical gyroscope where an off-chip laser is coupled to the integrated photonics front-end chip, which in turn couples to a fiber coil, according to an embodiment of the present disclosure.

FIG. 3 is a simplified schematic of an optical gyroscope where a laser and photodetectors are hybridly integrated to the electro-optic material based waveguide platform, according to an embodiment of the present disclosure.

FIG. 4A schematically illustrates a substrate with an isolation layer on top, upon which a thin film of electro-optic material is formed to make the waveguides of the front-end chip, according to an embodiment of the present disclosure.

FIG. 4B schematically illustrates a substrate with a thin film of electro-optic material directly formed on the substrate to make the waveguides of the front-end chip, according to an embodiment of the present disclosure.

FIG. 5 schematically illustrates distribution of waveguide components, including mode-selective filters, in a single layer of an integrated photonics front-end chip made from electro-optic materials, where a laser and detectors are outside of the front-end chip, according to an embodiment of the present disclosure.

FIG. 6 schematically illustrates distribution of electro-optic material based waveguide components in a single layer of the front-end chip, according to another embodiment of the present disclosure, where a laser and a Sagnac detector are housed on a common external substrate for self-aligned coupling with the integrated photonics components in the first layer of the front-end chip.

FIG. 7 schematically illustrates an isometric view of different layers of a multi-layer sensing chip with a rotation sensing element, where rotation sensing element is distributed among two layers, according to an embodiment of the present disclosure.

FIG. 8 schematically illustrates a longitudinal cross-sectional view (i.e. side view) of a multi-layer chip, according to an embodiment of the present disclosure.

FIG. 9 schematically illustrates distribution of rotation sensing element portions (or two rotation sensing elements) in two-sublayers of a sensing chip, where the sensing chip is a part of a multi-layer integrated photonics optical gyroscope, according to the embodiment of the present disclosure.

FIG. 10A illustrates a top view of the integrated photonics optical gyroscope where a laser and detector module is coupled to photonics components on a top layer of electro-optic material, while the second layer with the waveguide coil is underneath the top layer, according to an embodiment of the present disclosure.

FIG. 10B illustrates a side view of the integrated photonics optical gyroscope shown in the embodiment of FIG. 10A.

FIG. 10C illustrates a side view of the integrated photonics optical gyroscope where a laser and detector module is inserted into a cavity etched in the top layer of electro-optic material platform having photonics components, while another layer with the waveguide coil is underneath the top layer, according to an embodiment of the present disclosure.

FIG. 10D illustrates a top view of the integrated photonics optical gyroscope shown in FIG. 10C.

### DETAILED DESCRIPTION

Aspects of the present disclosure are directed to integration of fiber-based or compact low loss waveguide based angular rotation sensing element with other system-level integrated photonics components for optical gyroscope applications. The system integration is done with large scale manufacturing in mind to facilitate mass production of fully integrated photonics optical gyroscopes, or an integrated photonics front-end chip for a fiber-based optical gyroscope.

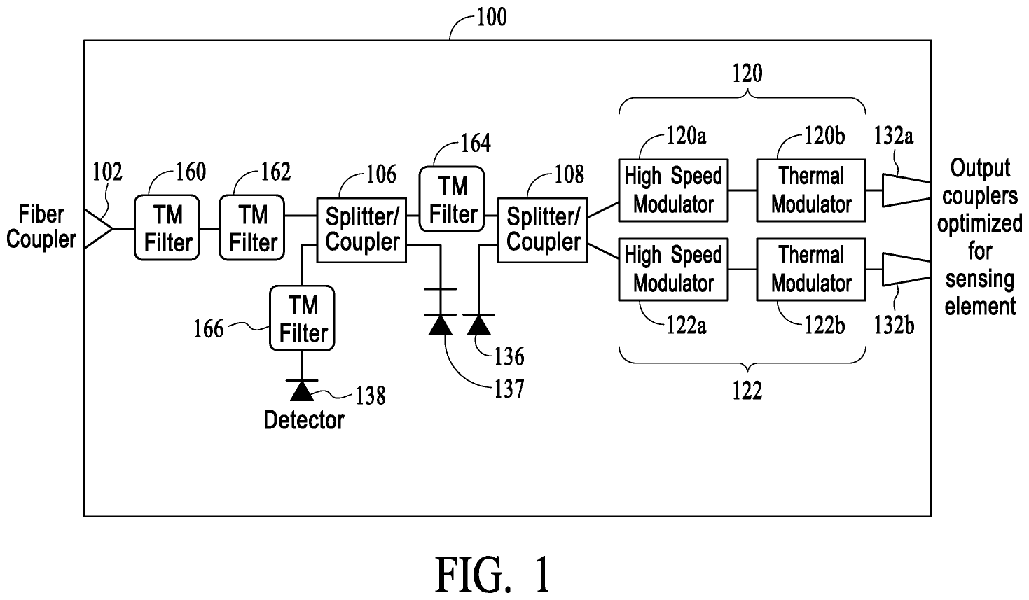

Optical gyroscopes may have a front-end chip made of integrated photonics components that can launch light to and receive light from a rotation sensing element. The rotation sensing element of the optical gyroscope can comprise a fiber loop or another integrated photonics waveguide chip (e.g, a silicon nitride or other material based waveguide-based coil or microresonator ring). FIG. 1 is a schematic of one embodiment of an integrated photonics front-end chip 100 that couples to a separate and distinct rotation sensing element (not shown here, but shown in later figures). The integrated photonics front-end chip 100 coupled with the rotation sensing element constitute an optical gyroscope module which may be part of an inertial measurement unit (IMU) package. Note that IMU may have other components, such as accelerometers, in addition to the optical gyroscope module. Therefore, making the optical gyroscope module compact reduces the overall size, weight power and cost of the IMU. This weight reduction can be crucial for certain applications, for example, lightweight unmanned aerial vehicles. IMU may be a much-needed technology component for more established sensing technologies for autonomous vehicles, such as LiDAR (Light Detection and Ranging), radar and cameras that will be used in future generation of autonomous vehicles (both terrestrial and aerial).

Previously, the current inventors have proposed making low-loss waveguides with a core made of silicon nitride (Si₃N₄), and the waveguide cladding may be made of fused silica or oxide. This waveguide structure is also referred to simply as SiN waveguide. Fabrication process for both configurations (i.e. SiN core in fused silica or SiN core in oxide) are described in the U.S. patent application Ser. No. 16/894,120, titled “Single-layer and multi-layer structures for integrated silicon photonics optical gyroscopes,” filed Jun. 5, 2020, now U.S. Pat. No. 10,969,548, issued Apr. 6, 2021, and U.S. patent application Ser. No. 17/249,603, titled, “Process flow for fabricating integrated photonics optical gyroscopes,” filed Mar. 5, 2021, now U.S. Pat. No. 11,187,532, issued Nov. 30, 2021, both of which are incorporated herein by reference.

In the prior art (such as what is shown in FIG. 1), the waveguide based components on front-end chip 100 may be based on Si or III-V compound semiconductor, or a combination thereof. In another embodiment of prior art, the waveguide based components of the front end chip may be fabricated on a all-SiN platform, as described in issued U.S. Pat. No. 11,371,842, titled, “Multi-layer Silicon Nitride Waveguide Based Integrated Photonics Optical Gyroscope Chip.”

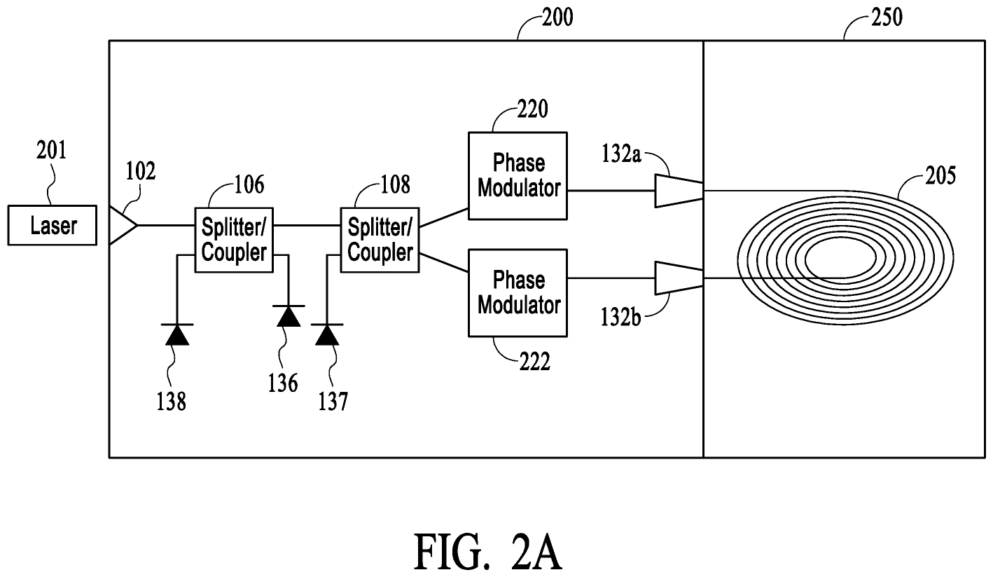

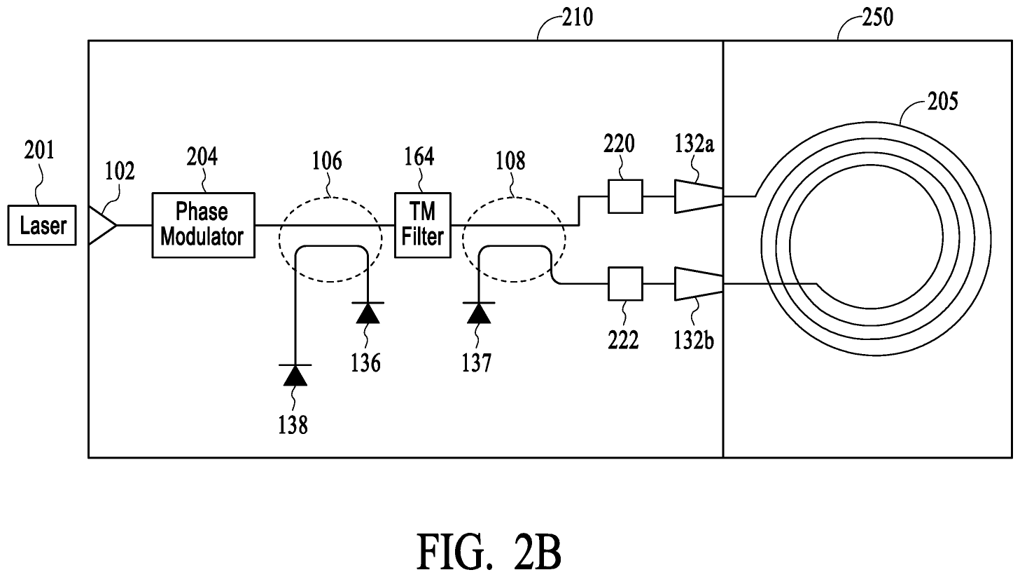

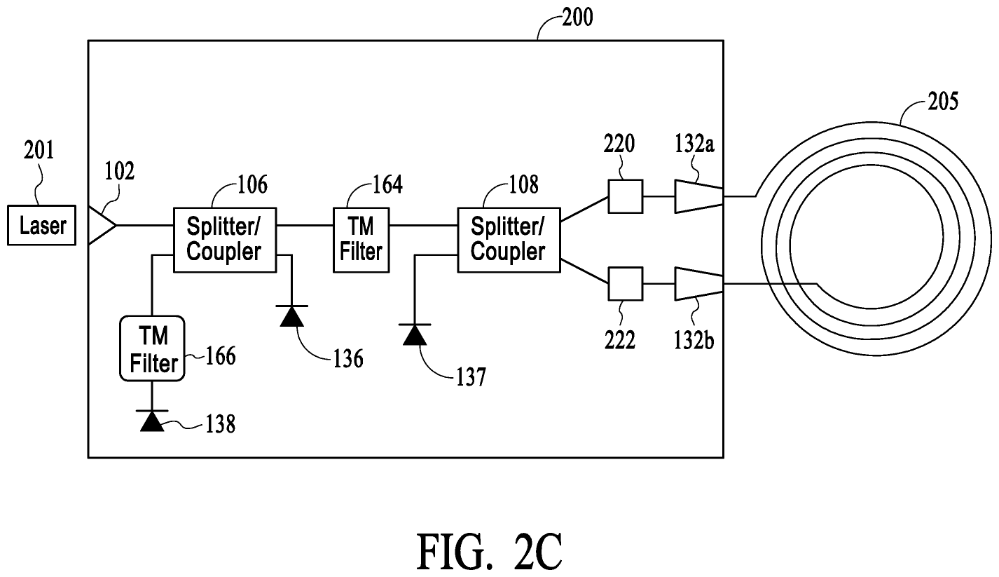

Referring back to FIG. 1, a light source (not shown in FIG. 1, but similar to laser 201 in FIG. 2A) is coupled to the integrated photonics front-end chip 100 via a fiber, or may be aligned with lens or may be butt-coupled. The light source can be a semiconductor laser made of III-V compound semiconductor. In case of coupling the laser with a fiber, typically a single-mode (SM) fiber is used. The single mode fiber may be a polarization maintaining fiber (PMF). The core size of a SM fiber is typically in the 8-10 μm range. An input waveguide on the integrated photonics front-end chip 100 may have to be designed with an end (input coupler 102) shaped to match the mode field diameter of the SM fiber for efficient coupling with the SM fiber carrying the optical signal from the laser source to the integrated photonics front-end chip 100. An optical tap (e.g., 0.5-1% or other target amount of optical power) may send part of the optical signal to a detector to measure the coupling efficiency between the laser source and the integrated photonics front-end chip (optical taps are not shown in the figures for simplicity). Optionally, an optical phase modulator may be inserted in the optical path that eventually leads to optical splitters/couplers 106 and 108. Note that, the elements 106 and 108 can be 2×2 splitter/coupler. In alternative embodiments, instead of 2×2 splitters, Y-couplers/Y-splitters or other type of couplers (e.g., directional coupler) may be used, as described with respect to FIG. 2B.

The splitters/couplers are designed on-chip to guide light coming back from the sensing element (such as 205 shown in FIG. 2A) into the detector 138. Detector 138 may be referred to as Sagnac detector—this is the key detector in the integrated photonics front-end chip 100 for phase measurement. The detector 138 may have to be isolated by implant around it (not shown) to block stray light. In addition to the Sagnac detector 138, additional detectors 136 and 137 may be incorporated to measure (for testing and/or monitoring) propagation and coupling losses at various places along the integrated photonics front-end chip 100 as well as to measure coupling efficiency between the integrated photonics front-end chip and the rotation sensing element. The detectors can be PIN or avalanche photodiodes that convert light to electrical signal. The material for the detectors can be silicon, germanium, silicon germanium or other compound semiconductors (such as indium phosphide (InP), gallium arsenide (GaAs) or other III-V semiconductors). Note that implant regions may be created around other waveguide-based components (in addition to the Sagnac detector), such as the splitters, couplers etc. to minimize stray light bouncing around in the chip.

Phase modulators may be incorporated in one or both of the two output branches of the waveguide leading to output couplers 132a and 132b that are optimized for coupling out to the rotation sensing element. In the non-limiting embodiment shown in FIG. 1, there are phase modulators/phase shifters 120 and 122 on both the output branches. Each branch may have both a high-speed modulator (120a and 122a) and a thermal modulator (120b and 122b), or just a high-speed modulator, or just a thermal modulator. Also, in some embodiments, only one branch may have phase modulator (high-speed, thermal, or a combination of high-speed and thermal), while the other branch does not have any phase modulator. In addition, mode-selective filters (such as TM filters which filters out most of the transverse-magnetic (TM) mode while passing transverse-electric (TE) mode) may be placed at various locations (e.g., mode filters 160, 162, 164 and 166) along the path of the optical beam. TM filters may be placed in multiple stages to improve extinction ratio between the TE and TM modes. Details of mode-selective filters and waveguide structures are covered in provisional application 62/904,443 filed on Sep. 23, 2019, titled, “System Architecture for Silicon Photonics Optical Gyroscopes with Mode-Selective Waveguides,” which was converted to non-provisional application Ser. No. 16/659,424, entitled, “System Architecture for Integrated Photonics Optical Gyroscopes,” filed Oct. 21, 2019, which is now issued as U.S. Pat. No. 10,731,988 on Aug. 4, 2020.

FIG. 2A is a simplified schematic of an optical gyroscope where an off-chip laser 201 is coupled to an integrated photonics front end chip 200 (similar to chip 100 in FIG. 1) via input coupler 102 (which could be a fiber coupler, or could be optimized for butt-coupling or coupling via a lens). The front-end chip 200 couples to a rotation sensing element 205 (such as a waveguide coil fabricated on a sensing chip 250), according to an embodiment of the present disclosure. The rotation sensing element 205 fabricated on sensing chip 250 can also be a microresonator ring. Note that for simplicity, some components (such as TM filter 164) of front-end chip 100 that are shown in FIG. 1 are not shown in chip 200 in FIG. 2A. The TM filter 164 is a key component in this design. The elements 106 and 108 may be Y-couplers, Y-splitters or directional couplers or multi-mode interference (MMI) devices acting as splitters/couplers. As unique to this application, the waveguides on chip 200 are made of a material that has electro-optic properties, such as lithium niobate or lithium tantalate. Electrodes 220 and 222 may be deposited on the waveguide branches leading to the sensing chip 250 to tune the optical phase shift by voltage or injection of current. Material of the electrodes may be gold, copper, platinum, chromium, aluminum or other materials. Additionally or alternatively, elements 220 and 222 may act as metal heaters which imparts additional thermal phase shift to the beam propagating within the waveguide branches leading to the sensing chip 250. Note that front-end chip 200 and sensing chip 250 can have different material platform, or they can have the same material platform. For example, front-end chip 200 may be made of electro-optic material platform and the sensing chip 250 may be made of electro-optic material platform or SiN platform other material platform. Also though in FIG. 2A the sensing chip 250 is shown side by side with the front-end chip 200, the sensing chip can be underneath or above the front-end chip 200 where light is coupled evanescently between the two chips. When the front-end chip 200 and the sensing chip 250 are made of the same material platform, they can be fabricated monolithically, or hybrid materials can be integrated together.

FIG. 2B is a simplified schematic of an alternative embodiment of the optical gyroscope shown in FIG. 2A, where an additional phase modulator 204 is added on the front-end chip 210 in between the off-chip laser 201 and the first optical coupler 106 (a directional coupler in this example). Both the elements 106 and 108 may be directional coupler or other types of splitters/couplers mentioned above. Note that for simplicity, the additional phase modulator 204 is not shown in some of the figures, but it can be added in any of the embodiments within the scope of this disclosure. Additional phase modulator 204 can be used to spread the linewidth of the laser 201. This allows for using a standard narrow linewidth laser (such as a Distributed Bragg Reflector (DFB) laser available at reasonable cost), and phase modulate the laser light to spread the linewidth. Since the material platform is made of electro-optic material, integration of electro-optic phase modulators at different locations of the chip should be accomplished easily, such as at the location of phase modulator 204. Like the elements 220 and 222, the element 204 can indicate electrode for electrical signal connection needed for modulating optical phase. Other types of optical phase modulation can also be used in addition to electro-optic phase modulation. Note that phase modulator 204 can combine phases of multiple on-chip or off-chip lasers. Details of phase modulation schemes can be found in application Ser. No. 16/659,424, entitled, “System Architecture for Integrated Photonics Optical Gyroscopes,” filed Oct. 21, 2019, which is now issued as U.S. Pat. No. 10,731,988 on Aug. 4, 2020.

FIG. 2C shows that the rotation sensing element 205 does not have to be a waveguide based coil/microresonator ring fabricated on a sensing chip 250, but it can simply be a fiber coil coupled to the front-end chip 200.

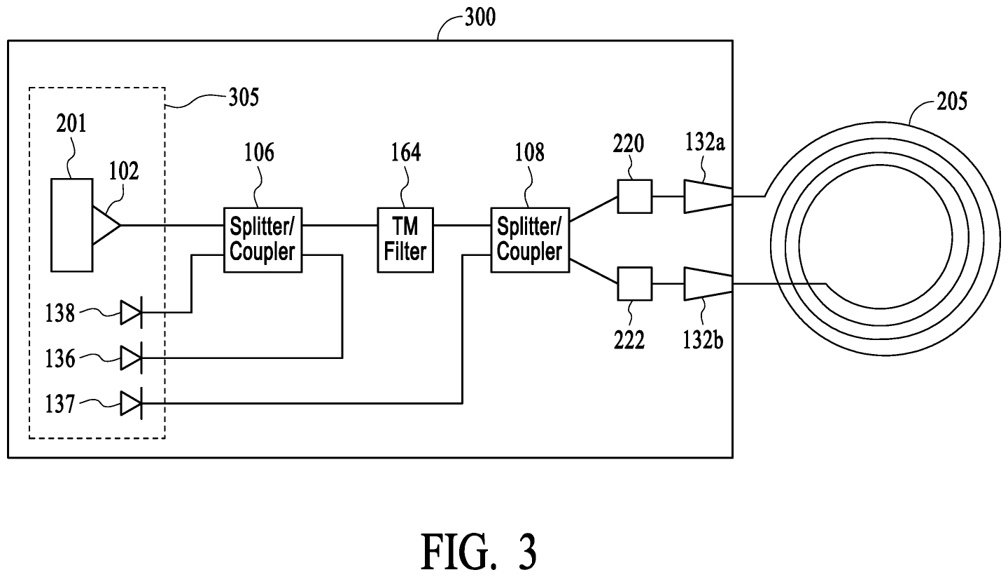

FIG. 3 shows an alternative embodiment 300 of front-end chip. In this embodiment, the laser 201 may also be on-chip, i.e. integrated onto front-end chip 300 via wafer bonding, flip-chip bonding or other hybrid integration approach, such as selective growing of laser material that is different from the platform material of the front-end chip 300. In the embodiment of FIG. 3, the platform material for the front-end chip 300 is an electro-optic material. All the waveguide-based optical components on the front-end chip 300, i.e. input coupler 102, splitter/couplers 106 and 108, output couplers 132a and 132b and the waveguide portions connecting these various optical components are made of the electro-optic platform material, with the exception of the laser 201, detectors 138, 136 and 137 and the electrodes 220 and 222 of the phase modulators. The detector 138 is the sagnac detector. The dotted outline 305 indicates different materials for the laser and detectors that are selectively grown on the electro-optic material platform or bonded to the electro-optic material platform. The sensing element 205 can be fiber or waveguide coil/ring.

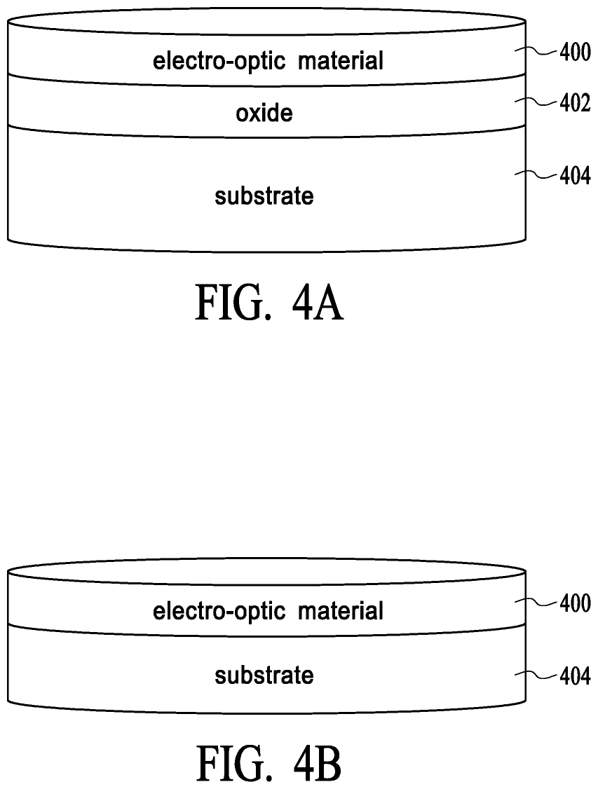

FIG. 4A shows the material platform for the front-end chip 200 or 300. A thin film 400 of electro-optic material (such as lithium niobate or lithium tantalate) can be grown or deposited on an isolation layer 402 on top of a substrate 404. The substrate 404 can be silicon or other material (like quartz, fused silica etc.). The isolation layer 402 could be silicon dioxide (SiO2). The substrate may be circular wafer with non-limiting illustrative diameter of 3-6 inches, though the scope of the disclosure is not limited by the substrate diameter. The thin film 400 may be 300-900 nm thick, though the scope of this disclosure does not depend on the dimension of the thin film 400. The thin film 400 may be single crystalline or polycrystalline. The isolation layer 402 can have a thickness of 1000-4000 nm though any other thickness is also within the scope of this disclosure. The thickness of the layers can be altered based on the design of the waveguide (for example a rib waveguide) to confine the optical modes.

FIG. 4B shows that the thin film 400 can be grown or deposited directly on the substrate 404 without an isolation layer 402.

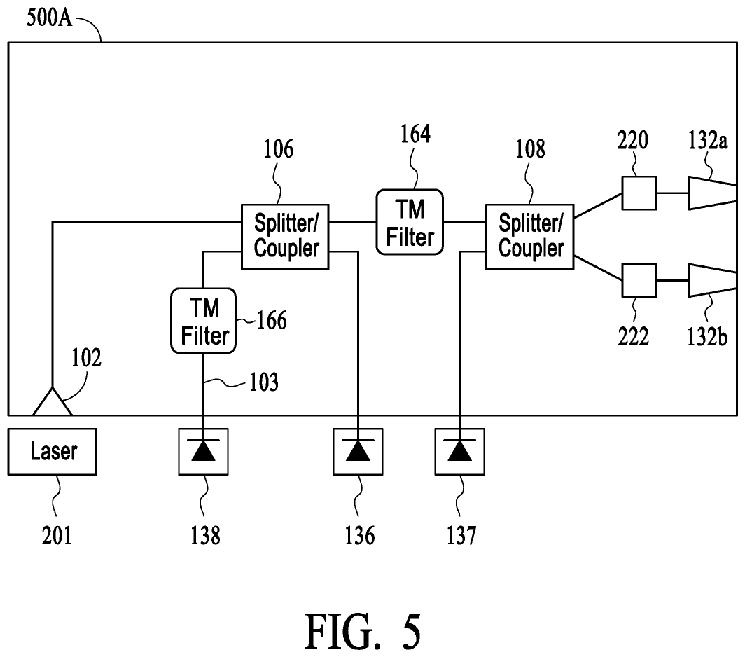

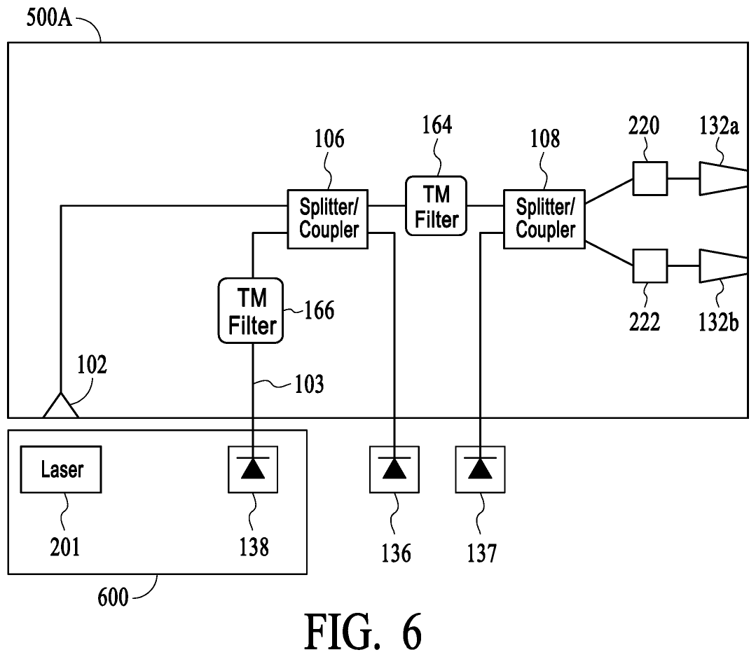

FIGS. 5-6 schematically illustrate distribution of electro-optic material based waveguide components in a layer 500A of the front-end chip. In this embodiment, the laser 201 and detectors 136, 137 and 138 are fabricated using a different material system (i.e. not thin film electro-optic material), and those would be the only components that would be outside of the front-end chip. The laser 201 and detectors 136, 137 and 138 need to be aligned and coupled to the front-end chip.

Note that that optionally there may be an additional phase shifter integrated with the at least one arm of the output branches of the waveguide coupled to the ends of the rotation sensing element. The phase shifter(s) may be a metal heater (thermal phase shifter) or a piezo-based or other electro-optic-based materials. Lithium niobate and lithium tantalate are commonly used electro-optic materials, but other electro-optic polymers/ceramics exist too. Other metals/polymers/ceramics may be deposited as a film (e.g., thin film) or bonded on the top of the electro-optic material platform. Examples of piezo-electric material include lead zirconate titanate (PZT). Other phase shifter materials suitable for integration with electro-optic material based waveguides include aluminum nitride (AlN), indium phosphide (InP), stronsium bismuth titanate (SBT) etc. Note that discrete optical devices with phase shifting material can also be fiber-coupled to the electro-optic material based waveguide platform. For example a PZT disc can be fiber-coupled with the electro-optic material based waveguide platform.

Integration of additional phase shifters can also be accomplished through wafer bonding of a III-V wafer or even silicon photonics wafer with the front-end chip. The phase shifter may be deposited/bonded/grown on the III-V wafer or silicon photonics wafer, which is then wafer bonded/flip-chip bonded to the front-end chip. The additional phase shifters, though made of a material other than the platform material, can be accessed (for electronic signal connection) from the top. In some embodiments, the electrodes for voltage (or current) connection to the phase shifters can be routed on the front-end chip.

Note that since the laser 201 and the detectors may be on-chip or may be in a separate chip that is outside of the front-end chip, they need to be aligned with the corresponding waveguide components formed in the electro-optic material layer 500A. FIG. 6 shows the laser 201 and the Sagnac detector 138 may be supported by a common substrate in module 600 which is then aligned to the layer 500A of the front-end chip. The lateral physical separation between the laser 201 and the detector 138 should match the lateral physical separation of the waveguides on the electro-optic material layer 500A. When the laser is aligned with the input coupler 102, the detector is automatically aligned to the directional coupler 103 without having to separately align the laser and the Sagnac detector. This design also automatically isolates the Sagnac detector from unwanted stray light that may leak into the substrate of layer 500A.

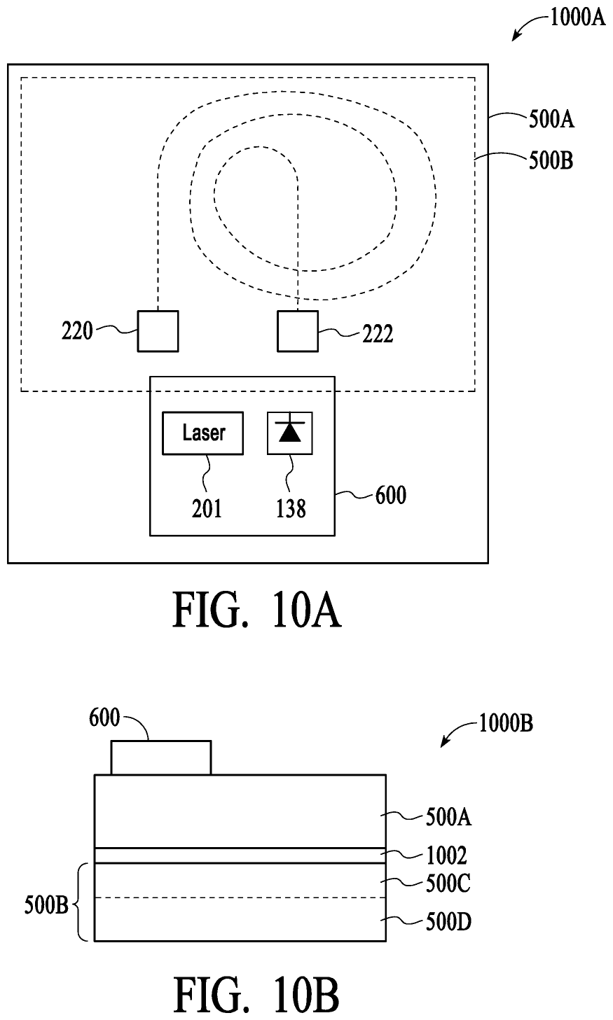

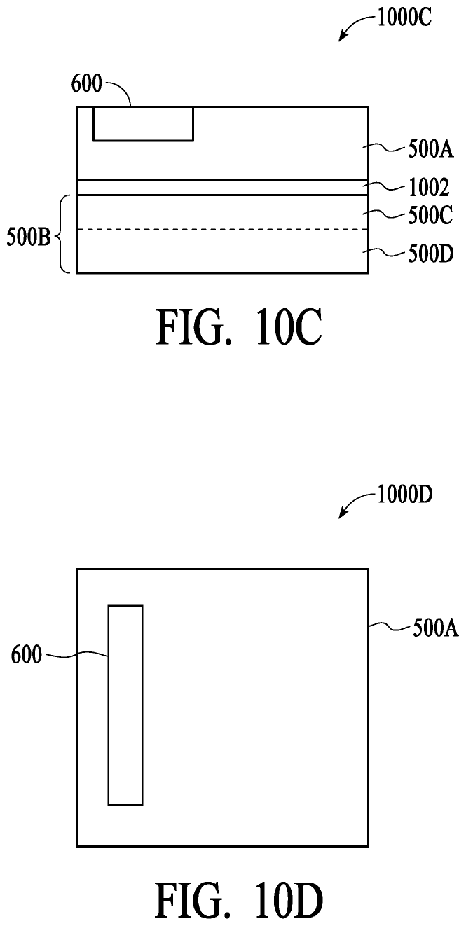

Note that in certain embodiments, the laser and detector module 600 may be coupled to the front-end chip from top, as shown in FIGS. 10A-10D. The laser and detector module 600 may be bonded/grown to the front-end chip or inserted into a slot etched into the front-end chip, as described further below.

The present inventors recognize that distributing the waveguide based optical components into different layers (e.g., two or more layers) could lead to better performance without increasing the form factor. In one embodiment, the front-end chip has just one layer, but the sensing chip with the sensing element (i.e. waveguide coil/microresonator ring) has two layers. Note that the sensing chip can be made with a different material platform, such as silicon nitride core with oxide/fused silica claddings, while the front-end chip has optical elements (such as the optical splitters, directional couplers, input or output couplers and mode-selective filters) that are made of an electro-optic material platform. In some embodiment, the waveguide coil can also be made of the electro-optic material platform. In other embodiments, the waveguide coil is made of a different material platform which can be bonded together with the electro-optic material platform.

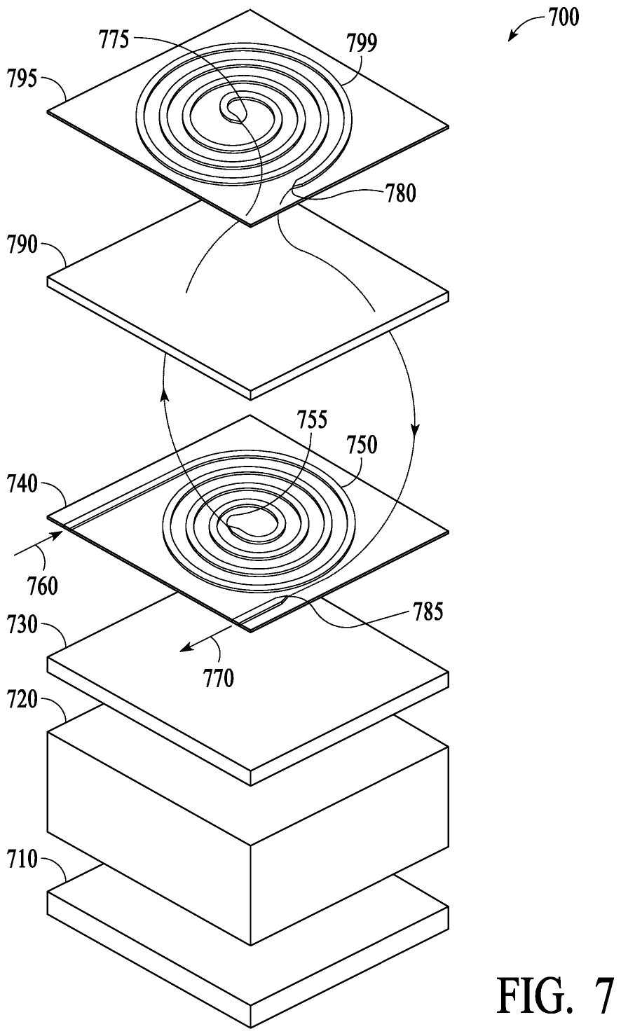

FIG. 7 is an exploded perspective view of a sensing chip 700 (equivalent to the sensing chip 250 shown in FIG. 2A) with a waveguide coil, where an output waveguide of the waveguide coil (that directs light back to the front-end chip after it propagates within the waveguide coil) does not intersect with the turns of the waveguide coil. There are portions of the waveguide coil both on the top plane and the bottom plane, and the output waveguide comes out from the same plane as the input waveguide that receives light from the front-end chip. This is an important aspect of the design, because efficient coupling with external components depends on the on the output waveguide and the input waveguide to be on the same plane. Also, by distributing the total length of the waveguide coil between two layers (top and bottom), intersection of waveguides can be avoided, which is a problem the conventional photonic gyros encounter, as the direction of propagation of light has to remain the same within the waveguide coil. In addition intersecting waveguides increases the scattering loss which the design in FIG. 7 can avoid.

In FIG. 7, the substrate 720 could be fused silica, or accomplished though other materials processing (e.g., Si and oxide). For example, layers 710, 730, 740, 790 and 795 are also fabricated via oxide and nitride growth (the spiral waveguides of the waveguide coil being a nitride core surrounded by oxide cladding). The input end of the waveguide coil that receives an optical signal is denoted as 760, wherein the output end is denoted as 770. The waveguide coil has a bottom portion 750 that spirals inwards to the tapered tip 755, where it couples up to the top layer 795 that has the rest of the waveguide coil (top portion 799). Thickness of a layer 790 (typically an oxide layer in between the layers 740 and 795) sets the coupling gap. The top portion 799 of waveguide coil starts from the tapered tip 775, and spirals outwards to the other tapered tip 780, from where light couples down to the tapered tip 785 of the waveguide on the bottom plane to go out via output port 770 (to a detector or other optical system components). The arrowed dashed lines show the coupling up and coupling down between the tapered tips in the two planes. The taper design and the vertical separation between the two layers with waveguides dictate coupling efficiency between the two planes. In order for light to couple between the two vertical planes, the tapered tips 755 and 375 must have some overlap, and the tapered tips 780 and 785 must have some overlap.

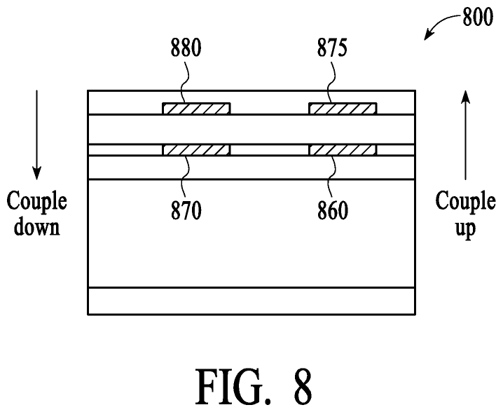

In one embodiment, the optical components of the front-end chip, such as the optical splitters, directional couplers, input or output couplers and mode-selective filters, can also be distributed among two layers. As shown in the cross section of the chip 800 in FIG. 8, multi-layer design requires the light coupled at the input waveguide 860 in the bottom layer to couple up from the bottom layer to the top to waveguide 875, and then again couple down from the waveguide 880 on the top layer to the bottom layer to be coupled out at the output waveguide 870. Note that the multi-layer configuration can be achieved via die stacking or via growth and processing of materials in multiple layers.

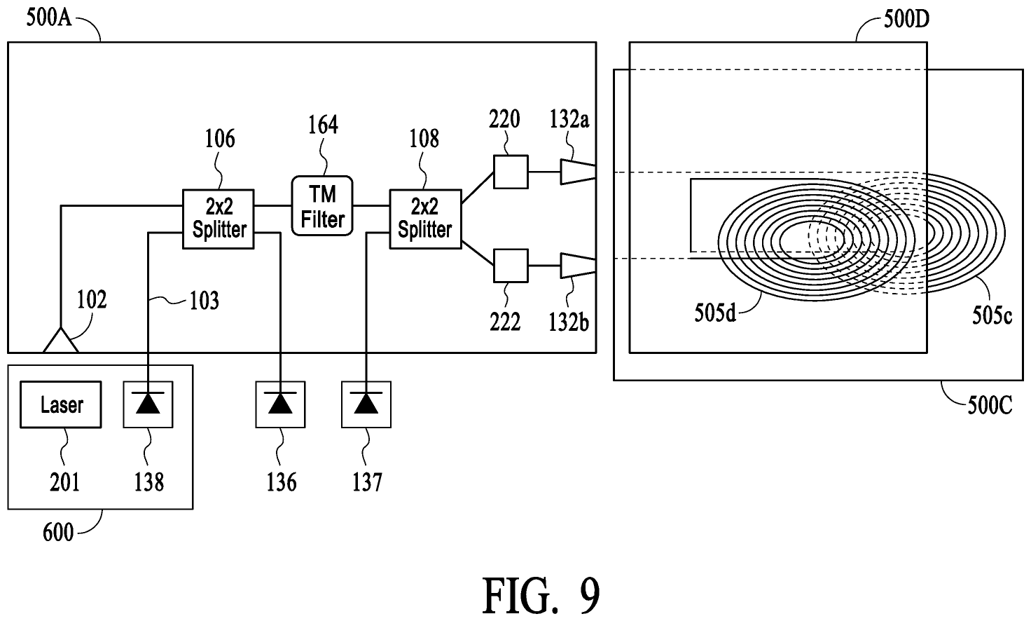

FIG. 9 illustrates that the waveguide coil 505 (equivalent to waveguide coil 205 shown in FIG. 2B) may be distributed among two or more vertical sub-layers, per the concept shown in FIG. 7. This enables a greater signal for the optical phase difference as more waveguide turns can be accommodated in the two or more layers than in one layer without increasing the footprint of the waveguide coil. Specifically, FIG. 9 shows that the layer 500A of the front-end chip vertically couples to sub-layer 500C which has a portion 505c of the waveguide coil 505. Portion 505c of the waveguide coil vertically couples to layer 500D, which has portion 505d of the waveguide coil 505. Note that the direction of light in portions 505c and 505d need to be the same. Sub-layers 500C and 500D in combination forms layer 500B, which is the layer for the sensing chip 250. Note that though for illustrative clarity the two layers 500D and 500C are shown slightly laterally offset to each other, in reality the waveguide coil portions 505c and 505d may be vertically aligned in a way that layer 500C is blocked from view by layer 500D when seen from the top.

In an alternate embodiment, two sub-layers 500C and 500D can have two separate waveguide coils (rather than portions of the same coil) for built-in redundancy. In another embodiment, each sub-layer 500C and 500D can have certain portions of each of the two separate waveguide coils.

FIGS. 10A-10B show (top view 1000A and side view 1000B respectively) that the laser and detector module 600 (shown earlier in FIG. 6) is bonded or grown on top of the electro-optic material layer 500A that typically has the input and output couplers, directional coupler, splitters, and filters, all based on waveguides made of the electro-optic material. Light is evanescently (or via physical waveguide) coupled in to the input coupler to layer 500A and coupled out to the detector from the layer 500A. The waveguide coil (shown in dashed line) is at least partially in the bottom layer 500B below the top layer 500A. The phase shifters (denoted by electrodes 220 and 222) may be on the top layer 500A. As shown in FIG. 10B, the top layer 500A and the bottom layer 500B may be vertically separated by a layer 1002 which helps in evanescent coupling between the layers 500A and 500B. Also, in some embodiments, layer 500B may be subdivided into multiple sub-layers (e.g., layers 500C and 500D, though three or more layers are also possible), each sub-layer having a portion of the waveguide coil.

FIGS. 10C-10D show (side view 1000C and top view 1000D respectively) that the laser and detector module 600 is inserted into a cavity etched in the electro-optic material layer 500A. Etched cavity facilitates in self-alignment of the laser and the detector module 600 with the corresponding integrated photonics waveguide components in electro-optic material layer 500A. Though in FIGS. 10C and 10D the waveguide coil is not shown, similar to FIG. 10B, the waveguide coil may be in layer 500B, which may be sub-divided into sub-layers 500C and 500D having portions of the waveguide coil.

In some embodiments, to accomplish hybrid integration of different materials with the electro-optic material platform, a separate chip with the laser and detectors (and perhaps other optical components) can be inserted into a cavity etched within the electro-optic material platform for automatic alignment of the phase shifter with the electro-optic material-based waveguides.

In some embodiments, all components that are not made of the electro-optic material are fabricated on a single external chip that is hybridly integrated/coupled and aligned with the waveguides on the electro-optic material platform. For example, the lasers and detectors can all be on a single external chip and attached or bonded to the electro-optic material platform.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense. Additionally, the directional terms, e.g., “top”, “bottom” etc. do not restrict the scope of the disclosure to any fixed orientation, but encompasses various permutations and combinations of orientations.

What is claimed is:

1. An integrated photonics optical gyroscope, comprising:
a front-end chip to launch light into and receive light from a rotation sensing element, the front-end chip comprising a plurality of waveguide-based optical components fabricated on a material platform having electro-optic properties.

2. The integrated photonics optical gyroscope of claim 1, wherein the material platform having electro-optic properties comprises: single crystalline or poly-crystalline lithium niobate platform.

3. The integrated photonics optical gyroscope of claim 1, wherein the material platform having electro-optic properties comprises: single crystalline or poly-crystalline lithium tantalate platform.

4. The integrated photonics optical gyroscope of claim 1, wherein the plurality of waveguide-based optical elements comprise:
at least one phase shifter coupled to one of a first end or a second end of the rotation sensing element.

5. The integrated photonics optical gyroscope of claim 4, further comprising:
an additional phase shifter fabricated by depositing, growing or bonding a piezo-electric material on top of the material platform having electro-optic properties.

6. The integrated photonics optical gyroscope of claim 4, further comprising:
an additional phase shifter fabricated by depositing, growing or bonding a metallic heater on top of the material platform having electro-optic properties.

7. The integrated photonics optical gyroscope of claim 4, further comprising:
an additional phase shifter fabricated by growing, wafer-bonding or attaching III-V compound semiconductor material on top of the material platform having electro-optic properties.

8. The integrated photonics optical gyroscope of claim 1, wherein the plurality of waveguide-based optical components include one or more from: optical splitters, directional couplers, input couplers, output couplers, and mode-selective filters.

9. The integrated photonics optical gyroscope of claim 1, wherein a semiconductor light source is hybridly integrated or coupled with the material platform having electro-optic properties.

10. The integrated photonics optical gyroscope of claim 9, wherein one or more photodetectors are hybridly integrated or coupled with the material platform having electro-optic properties.

11. The integrated photonics optical gyroscope of claim 10, wherein the semiconductor light source and the one or more photodetectors are integrated on a common substrate which is then coupled to the material platform having electro-optic properties.

12. The integrated photonics optical gyroscope of claim 11, wherein the common substrate is wafer-bonded or flip-chip bonded with the front-end chip.

13. The integrated photonics optical gyroscope of claim 12, wherein the common substrate is self-aligned or coupled with the front-end chip.

14. The integrated photonics optical gyroscope of claim 9, wherein the semiconductor light source is selectively grown on the material platform having electro-optic properties.

15. The integrated photonics optical gyroscope of claim 10, wherein the one or more photodetectors selectively grown on the material platform having electro-optic properties.

16. The integrated photonics optical gyroscope of claim 1, wherein the rotation sensing element is a fiber spool.

17. The integrated photonics optical gyroscope of claim 1, wherein the rotation sensing element is a waveguide coil or a microresonator ring.

18. The integrated photonics optical gyroscope of claim 1, wherein the waveguide coil or the microresonator ring is fabricated on the material platform having electro-optic properties.

19. The integrated photonics optical gyroscope of claim 8, wherein the optical splitters are 2×2 splitters or multi-mode interference (MMI)-based devices.

20. The integrated photonics optical gyroscope of claim 8, wherein the mode-selective filter filters out transverse-magnetic (TM) mode.
